(19) United States
(12) Patent Application Publication
(10) Pub. No.: US 2026/0301425 A1
(43) Pub. Date: Oct. 1, 2026

(54) METHOD FOR TRAINING A PERCEPTION SYSTEM FOR A VEHICLE

(71) Applicant: Robert Bosch GmbH, Stuttgart (DE)

(72) Inventors: Daniel Kenta Jenet, Stuttgart (DE); Felix Huttner, Ditzingen (DE); Hans-Georg Raumer, Hildesheim (DE); Max Kirstein, Hohenhameln - Ot Bruendeln (DE); Peter Hurt, Filderstadt (DE); Sascha Braun, Reutlingen (DE); Thomas Wenzel, Hamburg (DE); Thorben Funke, Sarstedt (DE)

(21) Appl. No.: 19/568,946

(22) Filed: Mar. 17, 2026

(30) Foreign Application Priority Data
Mar. 31, 2025 (DE) 10 2025 112 418.3

(51) Int. Cl. G06V 20/58; G06V 20/56

(52) U.S. Cl. CPC G06V 20/58; G06V 20/588

(57) ABSTRACT

A computer-implemented method for training a perception system for a vehicle. The method includes: providing a first training dataset, wherein the first training dataset comprises unlabeled environmental sensor data; executing a first training step of a map prediction module of the perception system to generate a map representation of the environment of the vehicle based on the environmental sensor data of the first training dataset; providing a second training dataset, wherein the second training dataset comprises labeled environmental sensor data; and executing a second training step of the map prediction module of the perception system pretrained in the first training step, to generate the map representation of the environment based on the labeled environmental sensor data of the second training dataset, wherein the generation of the map representation is designed as an onboard map generation.

### CROSS REFERENCE

The present application claims the benefit under 35 U.S.C. § 119 of Germany Patent Application No. DE 10 2025 112 418.3 filed on Mar. 31, 2025, which is expressly incorporated herein by reference in its entirety.

### FIELD

The present disclosure relates to a method for training a perception system for a vehicle.

### BACKGROUND INFORMATION

Certain perception systems for vehicles and methods for training such perception systems are described in the related art.

It is an object of the present disclosure to provide an improved method for training a perception system for a vehicle.

### SUMMARY

The object may be achieved by a method and an inertial measurement unit have certain features disclosed herein. Advantageous embodiments are disclosed herein.

According to one aspect, a computer-implemented method for training a perception system for a vehicle is provided. According to an example embodiment, the method comprises: providing a first training dataset, wherein the first training dataset comprises unlabeled environmental sensor data, and wherein the environmental sensor data reproduce an environment of a vehicle;
executing a first training step of a map prediction module of the perception system to generate a map representation of the environment of the vehicle on the basis of the environmental sensor data of the first training dataset; and
providing a second training dataset, wherein the second training dataset comprises labeled environmental sensor data; and
executing a second training step of the map prediction module of the perception system pretrained in the first training step, to generate the map representation of the environment on the basis of the labeled environmental sensor data of the second training dataset, wherein the generation of the map representation is designed as an onboard map generation.

This can achieve a technical advantage that an improved method for training a perception system for a vehicle can be provided. According to an example embodiment, for this purpose, a map prediction module of the perception system is trained in a first training step on unlabeled environmental sensor data of a first training dataset to generate a map representation of an environment of a vehicle on the basis of the environmental sensor data of the first training dataset.

In a subsequent second training step, the previously trained map prediction module of the perception system is trained to generate the map representation of the environment on the basis of labeled environmental sensor data of a second training set.

The map representation is generated as an onboard map generation that takes place during the operation of the vehicle. The map generation module can be pretrained by executing the first training step.

The pretraining is performed on unlabeled data, as a result of which the first training step can be greatly simplified, since there is no need for time-consuming labeling of the environmental sensor data of the first training dataset.

By pretraining the map generation module on the unlabeled environmental sensor data of the first training dataset, the training of the pretrained map generation module on the basis of the labeled environmental sensor data of the second training dataset can be improved, and a correspondingly improved, trained map generation module can be provided.

According to one example embodiment, the first training step is designed as self-supervised training, and/or wherein the second training step is executed taking into account ground truth information, and/or wherein the ground truth information is based on a high-resolution map.

This can achieve the technical advantage that self-supervised training of the map generation module in the first training step allows precise pretraining of the map generation module on the basis of unlabeled data.

Because the second training step is executed taking into account ground truth information, precise training of the map generation module can be achieved, wherein the ground truth information is based on a high-resolution map, precise training of the map generation module to generate a corresponding map representation can be achieved.

According to one example embodiment, the method further comprises:
receiving map data of an electronic road map by the perception system, wherein the map data reproduce the environment of the vehicle, and/or wherein the road map is designed as a standard resolution map;
ascertaining road marking information on the basis of the map data; and
taking into account the map data of the road map, to which the road marking information has been added, as a pseudo-label in the training of the map prediction module in the first training step.

The technical advantage can thereby be achieved that, by taking into account the map data of the electronic road map, the information of the electronic road map can be used as a map prior for the training to generate the map representation.

In particular, further improvements can be achieved by taking into account the road marking information of the electronic road map as a pseudo-label in the training of the map prediction module in the first training step of the pretraining of the map generation module.

According to one example embodiment, the ascertainment of the road marking information comprises:
extracting a map extract from the road map for each data point of the environmental sensor data, wherein the map extract is arranged around a vehicle position defined by the relevant data point;
converting the extracted map extract into vehicle coordinates; ascertaining the road marking information on the basis of the vehicle coordinates, taking into account estimated road widths and estimated numbers of lanes per road.

The technical advantage can thereby be achieved that the information of the electronic road map can be adapted more precisely to the environmental sensor data. For each position of the vehicle, which is given by the position information of the environmental sensor data, an extract comprising the relevant vehicle position is extracted from the electronic road map.

It can thereby be ensured that the information of the electronic road map is limited to the relevant vehicle position. The information of the road map can thereby be taken into account even more precisely as the map prior in the training of the map prediction module.

According to one example embodiment, the road width and/or the number of lanes is estimated on the basis of information relating to the road type and/or the lane type and/or on the basis of country-specific and/or region-specific information, and/or wherein the map extracts are ascertained taking into account a selectable prediction range, and/or wherein the vehicle positions are ascertained taking into account GPS-based position information and/or on the basis of visual landmarks, and/or wherein the ascertainment of the road marking information comprises:
combining the ascertained lanes to form lines and/or line segments.

The technical advantage can thereby be achieved that the information provided by the electronic road map and taken into account in the training can be made even more precise.

According to one example embodiment, the environmental sensor data of the first and/or second training datasets comprise image data and/or video data, and/or wherein the method further comprises:
converting the environmental sensor data of the first training dataset and/or of the second training dataset into birds-eye-view features; and
extracting map features on the basis of the birds-eye-view features, wherein the map features serve as input data for the map prediction module.

The technical advantage can thereby be achieved that the training of the map prediction module can be further improved by converting the environmental sensor data into birds-eye-view features.

According to one example embodiment, the first training step and/or the second training step further comprise: training a detection module of the perception system for object detection and/or training an occupancy module of the perception system for generating an occupancy network.

The technical advantage can thereby be achieved that additional functions of the perception system can be integrated into the training. Comprehensive training of the perception system can thereby be provided.

According to one example embodiment, separate partial loss functions are used for training the map prediction module and/or the object detection module and/or the occupancy network module, and/or wherein a total loss function comprising the partial loss functions is used for training the perception system, and wherein the partial loss functions are combined in a weighted sum in the total loss function.

This can achieve the technical advantage that a further improvement in the training of the perception system is made possible.

According to one aspect, a computing unit is provided which is configured to carry out the method according to one of the above-described embodiments for training a perception system for a vehicle that can be driven autonomously.

According to one aspect, a computer program product is provided which comprises commands that, when the program is executed by a data processing unit, cause the data processing unit to carry out the method according to one of the above-described embodiments for training a perception system for a vehicle that can be driven autonomously.

Embodiments of the present disclosure are described with reference to the figures.

### BRIEF DESCRIPTION OF THE DRAWINGS

FIG. 1 is a schematic representation of the training of a perception system for a vehicle according to one example embodiment.

FIG. 2, including graphics a) and b), is a schematic representation of the extraction of road marking information according to one example embodiment.

FIG. 3 is a further schematic representation of the training of the perception system for a vehicle according to a further example embodiment.

FIG. 4 is a flowchart of a method for training a perception system for a vehicle according to one example embodiment.

FIG. 5 is a further flowchart of a method for training a perception system for a vehicle according to a further example embodiment.

FIG. 6 is a schematic representation of a computer program product.

### DETAILED DESCRIPTION OF EXAMPLE EMBODIMENTS

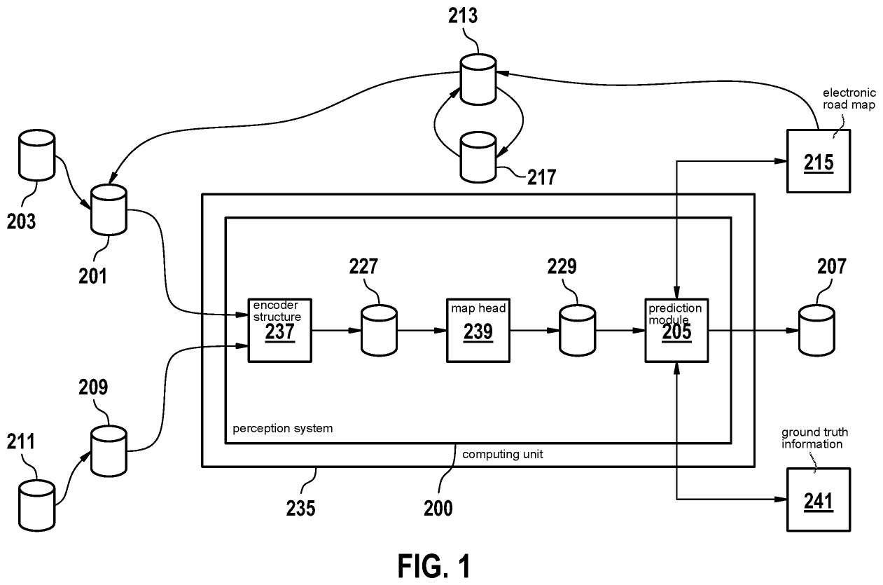

FIG. 1 shows a schematic representation of the training of a perception system 200 for a vehicle according to one example embodiment.

In the embodiment shown, the perception system 200 comprises an encoder structure 237. The encoder structure 239 comprises a birds-eye-view BEV encoder, via which the perception system 200 is configured to generate birds-eye-view features 227 on the basis of environmental sensor data 203, 211.

In the embodiment shown, the perception system 200 further comprises a map head 239. By means of the map head 239, the perception system 200 is configured to generate map features 229 on the basis of the birds-eye-view features 227. The perception system 200 is further configured, via a prediction module 205, to generate the map representation 207 on the basis of the map features 229.

The map head 239 can be designed, for example, according to Liao et al.: B. Liao, S. Chen, X. Wang, T. Cheng, Q. Zhang, W. Liu, and C. Huang, “Maptr: Structured modelling and learning for on-line vectorized hd map construction,” arXiv preprint arXiv: 2208.14437, 2022.

Alternatively, the map head 239 can be designed according to Li et al.: T. Li, P. Jia, B. Wang, L. Chen, K. Jiang, J. Yan, and H. Li, “Lanesegnet: Map learning with lane segment perception for autonomous driving,” arXiv preprint arXiv: 2312.16108, 2023.

According to the present disclosure, the generation of the map representation 207 is effected as an onboard map generation. The onboard map generation describes that the map representation 207 is created during operation of the vehicle, at least on the basis of the environmental sensor data 203, 211.

The environmental sensor data 203, 211 can, for example, be in the form of image data or video data and reproduce an environment of the relevant vehicle.

According to one embodiment, the transformation of the environmental sensor data 201, 211 in the form of image data or video data into BEV features 227 by the BEV encoder is effected according to Yang et al.: C. Yang, Y. Chen, H. Tian, C. Tao, X. Zhu, Z. Zhang, G. Huang, H. Li, Y. Qiao, L. Lu, et al., “Bev-former v2: Adapting modern image backbones to bird's-eye-view recognition via perspective supervision,” in Proceedings of the IEEE/CVF Conference on Computer Vision and Pattern Recognition, pp. 17830-17839, 2023.

According to one embodiment, the generation of the map representation 207 is effected by the map prediction module 205 on the basis of the map features 229 according to Liao et al. or Li et al.

According to the present disclosure, the perception system 200 is trained in a two-part training approach.

In a first training step, the perception system 200 is trained on the basis of unlabeled environmental sensor data 203 of a first training dataset 201 to generate the map representation 207. The first training step in this case constitutes pre-training of the perception system 200.

In a subsequent second training step, the perception system 200 that was pretrained in the first training step is trained on the basis of labeled environmental sensor data 211 of a second training dataset 209 to generate the map representation 207.

During the pretraining in the first training step, the weights of the perception system 200 are provided with initial values for the subsequent actual training of the perception system 200 in the second training step. The performance of the training of the perception system for generating the map representation 207 can thereby be improved.

According to one embodiment, the first training step is executed as self-supervised training. The second training step, however, can be effected taking into account ground truth information 241.

According to one embodiment, for the pretraining in the first training step, map data 213 of an electronic road map 215 can be used as additional information to the unlabeled environmental sensor data 203 of the first training dataset 201.

For this purpose, road marking information 217 of the map data 213 of the electronic road map 215 can be used as a pseudo-label for the unlabeled environmental sensor data 203 of the first training dataset 201.

For this purpose, the encoder structure 239 comprises a map encoder. Via the map encoder, the perception system 200 is configured to convert the map data 213 into feature vectors.

The map encoder can be designed according to Luo et al.: K. Z. Luo, X. Weng, Y. Wang, S. Wu, J. Li, K. Q. Weinberger, Y. Wang, and M. Pavone, “Augmenting lane perception and topology under-standing with standard definition navigation maps,” in 2024 IEEE International Conference on Robotics and Automation (ICRA), pp. 4029-4035, IEEE, 2024.

Alternatively, the map encoder can be designed according to Wu et al.: H. Wu, Z. Zhang, S. Lin, T. Qin, J. Pan, Q. Zhao, C. Xu, and M. Yang, “Blos-bev: Navigation map enhanced lane segmentation network, beyond line of sight,” in 2024 IEEE Intelligent Vehicles Symposium (IV), pp. 3212-3219, IEEE, 2024.

Alternatively, the map encoder can be designed according to Zhang et al.: H. Zhang, D. Paz, Y. Guo, A. Das, X. Huang, K. Haug, H. I. Christensen, and L. Ren, “Enhancing online road network perception and reasoning with standard definition maps,” arXiv preprint arXiv: 2408.01471, 2024.

Via a suitably designed fusion, the feature vectors of the map encoder are fused into the BEV features 227.

The electronic road map 215 is used here as a map prior, as may be the case in the related art, and provides information relating to the traffic infrastructure within the environment of the vehicle reproduced by the environmental sensor data 203. The electronic road map 215 comprises the information relating to the traffic infrastructure that is usual for electronic road maps.

To take into account the information of the electronic road map as a pseudo-label for the unlabeled environmental sensor data 203, a map extract is extracted from the road map 215 for each data point of the environmental sensor data 203 and converted into vehicle coordinates.

The road marking information 217 is ascertained on the basis of the vehicle coordinates, taking into account estimated road widths and estimated numbers of lanes of the roads of the reproduced infrastructure that are represented by the map extract.

This additional information on the unlabeled environmental sensor data 203 facilitates the pretraining of the perception system 200 to generate the map representation 207.

By taking into account the road marking information in the unlabeled environmental sensor data 203 of the first training dataset, the perception system 200 learns to recognize or output typical shapes of lane markings or road markings in the form of straight parallel lines or curved lines in pretraining during the first training step.

Through such pretraining, the perception system 200 learns the exact position and shape of the road markings more quickly in the subsequent actual training during the second training step, taking into account the exact ground truth information 241, and improved performance of the training of the perception system 200 can be achieved.

According to one example embodiment, the electronic road map 215, which serves to provide the road marking information 217 as a pseudo-label for the unlabeled environmental sensor data 203 of the first training dataset 201, is designed as an SD card, such as Open Street Map. The electronic road map 215 comprises information about the general course of the roads, as well as information about the number of lanes on each road.

In FIG. 1, the perception system 200 is shown to be executable on a computing unit 235.

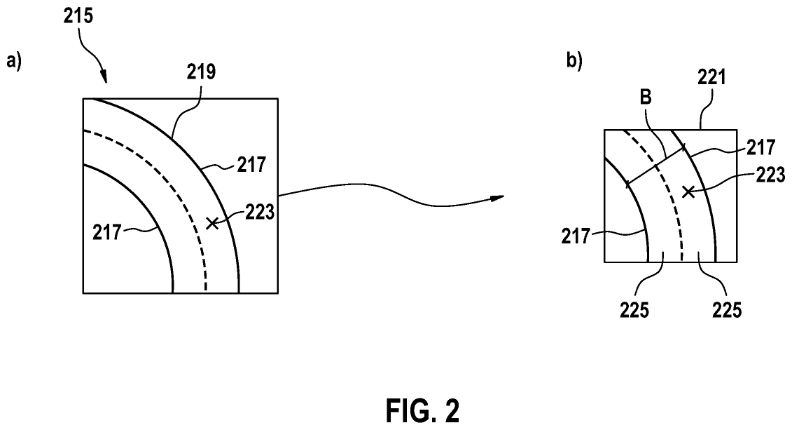

FIG. 2 shows a schematic representation of the extraction of road marking information 217 according to one embodiment.

FIG. 2 shows the creation of a map extract 221 from the electronic road map 215 to determine the road marking information 217, to use this road marking information 217 as a pseudo-label in the first training dataset 201 for the execution of the pre-training in the first training step.

Graphic a) shows the electronic road map 215. The electronic road map 215 shows a road 219 having a plurality of lanes 225 by way of example. The road 219 is bordered by road markings 217. In graphic a), a vehicle position 223 is also shown relative to the road map 215.

The vehicle position 223 corresponds here to a position of the vehicle that is given by the position information of the environmental sensor data 203 within the first training dataset 201.

The vehicle position 223 can be ascertained, for example, via GPS information of the environmental sensor data 203. By transferring the GPS information into the electronic road map 215, the vehicle position 223 of the relevant environmental sensor data 203 can be transferred into the electronic road map 215.

Graphic b) shows a relevant created map extract 221, which is arranged around the identified vehicle position 223. The size of the map extract 221 can be ascertained, for example, via the selected prediction range, for example 50 m to the front and rear and 20 m to the left and right of the vehicle position 223.

The map data 213 of the electronic road map 215, in particular the map extracts 221, are taken into account for each training data sequence or training data frame of the unlabeled environmental sensor data 203.

The map extracts 221 are generated for each vehicle pose of the training data sequences or training data frames of the unlabeled environmental sensor data 203.

To ascertain the road boundary information 217, the information of the map extract 221 can first be transformed into vehicle coordinates. First, a localization is carried out, for example on the basis of GPS or visual landmarks. The road markings 217 are then estimated.

The positioning of the road markings 217 can be estimated taking into account estimated road widths B and estimated numbers of lanes 225 per road 219.

The road type can also be taken into account in the estimation of the road boundary 217. For example, a motorway is wider than a residential street. Furthermore, information about the type of lanes, such as bicycle lanes or bus lanes, can be taken into account. Additional specific assumptions can also be made on the basis of this information.

When ascertaining the positions or courses of the road markings 217, the road type and/or the lane type and/or region-specific information relating to the average design of roads 219 can also be taken into account.

If the map representation 207 is generated by the perception system 200 according to Liao et al., the results for the road markings 217 can be used directly from the algorithm. If, however, the map generation is carried out according to Li et al., the individual lanes of the road 219 are first converted into line segments.

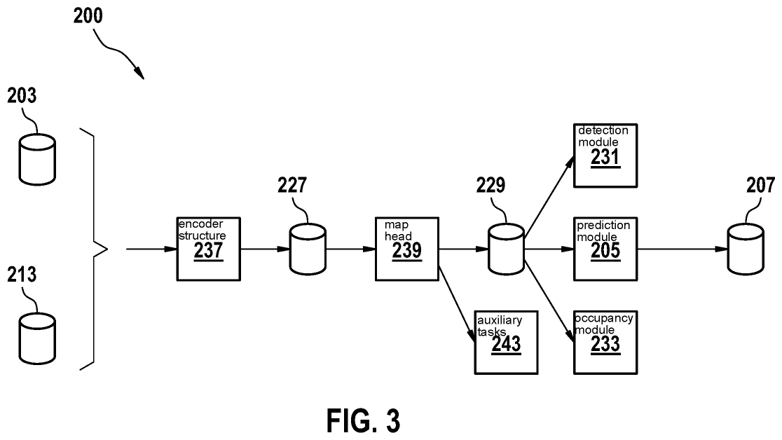

FIG. 3 shows a further schematic representation of the training of the perception system 200 for a vehicle according to a further embodiment.

In the embodiment shown, the perception system 200 comprises, in addition to the map prediction module, a detection module 231 for executing object detection and an occupancy module 233 for ascertaining an occupancy map. The detection module 231 and the occupancy module 233 can also be integrated into the training according to the embodiment shown in FIG. 1.

In the embodiment shown, auxiliary tasks 243, such as time pre-dictions, can also be taken into account.

The pretraining can be carried out according to Yang et al.: Z. Yang, L. Chen, Y. Sun, and H. Li, “Visual point cloud forecasting enables scalable autonomous driving,” in Proceedings of the IEEE/CVF Conference on Computer Vision and Pattern Recognition, pp. 14673-14684, 2024.

Alternatively, the pretraining can be performed according to Yang et al.: S. Xu, F. Li, S. Jiang, Z. Song, L. Liu, and Z.-x. Yang, “Gaussianpretrain: A simple unified 3d gaussian representation for visual pre-training in autonomous driving,” arXiv preprint arXiv: 2411.12452, 2024.

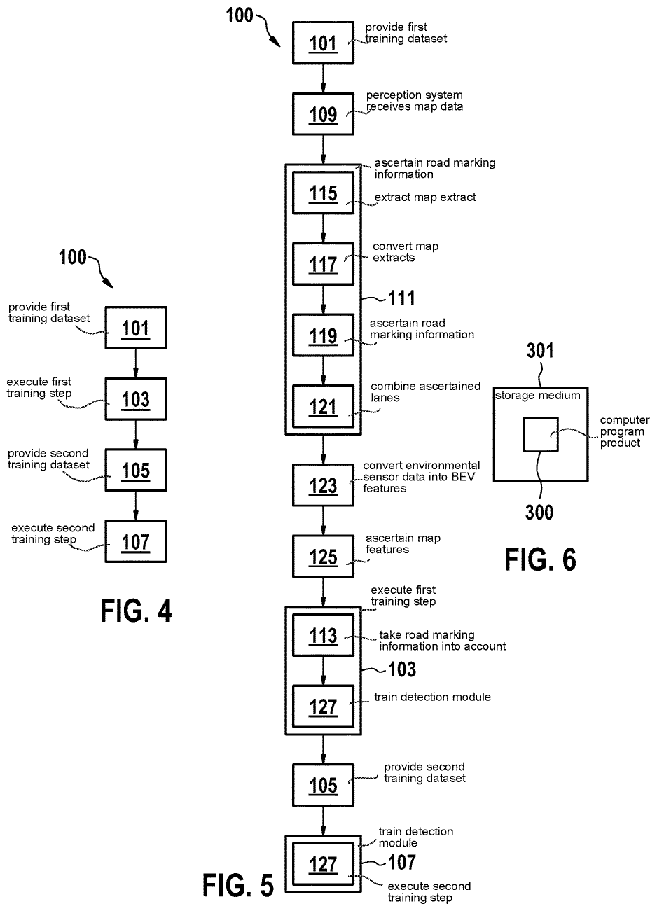

FIG. 4 shows a flowchart of a method 100 for training a perception system 200 for a vehicle according to one embodiment.

To train the perception system 200, in a first method step 101, a first training dataset 201 having unlabeled environmental sensor data 203 is initially provided.

In a further method step 103, the first training step of the map prediction module 205 of the perception system 200 is executed to generate the map representation 207 on the basis of the environmental sensor data 203 of the first training dataset 201.

In a further method step 105, the second training dataset 209 having the labeled environmental sensor data 211 is provided.

In a further method step 107, the second training step of the map prediction module 205 that was pretrained in the first training step is executed to generate the map representation 207 on the basis of the labeled environmental sensor data 211 of the second training dataset 209.

FIG. 5 shows a further flowchart of a method 100 for training a perception system 200 for a vehicle according to a further embodiment.

The embodiment in FIG. 5 is based on the embodiment in FIG. 4.

In a further method step 109, the perception system 200 receives map data 213 of an electronic road map 215.

In a further method step 111, road marking information 217 of the road 219 of the road map 215 is ascertained on the basis of the map data 213.

For this purpose, in a method step 115, a map extract 221 is extracted from the road map 215 for each data point of the environmental sensor data 203.

In a further method step 117, the map extracts 221 are converted into vehicle coordinates.

In a further method step 119, the road marking information 217 is ascertained on the basis of the vehicle coordinates, taking into account estimated road widths B and estimated numbers of lanes 225 per road 219.

In a further method step 121, the ascertained lanes are combined into lines and/or line segments.

In a further method step 123, the environmental sensor data of the first training dataset 201 and/or of the second training dataset 209 are converted into birds-eye-view BEV features 227.

In a further method step 125, map features 229 are ascertained on the basis of the BEV features 227 by executing a map head 239.

To execute the first training step, in a method step 113, the road marking information 217 is taken into account as a pseudo-label in the training of the map prediction module 205.

In a further method step 127, a detection module 231 for object detection and/or an occupancy module 233 for generating an occupancy network are also trained.

In the second training step, the detection module 231 and/or the occupancy module 233 are trained in a further method step 127.

FIG. 6 shows a schematic representation of a computer program product 300 comprising commands that, when the program is executed by a data processing unit, cause the data processing unit to carry out the method 100 for training a perception system 200 for a vehicle.

In the embodiment shown, the computer program product 300 is stored on a storage medium 301. Here, the storage medium 301 can be any storage medium from the related and prior art.

What is claimed is:

1. A computer-implemented method for training a perception system for a vehicle, comprising:
providing a first training dataset, wherein the first training dataset includes unlabeled environmental sensor data, and wherein the environmental sensor data reproduce an environment of a vehicle;
executing a first training step of a map prediction module of the perception system to generate a map representation of the environment of the vehicle based on the environmental sensor data of the first training dataset;
providing a second training dataset, wherein the second training dataset includes labeled environmental sensor data; and
executing a second training step of the map prediction module of the perception system pretrained in the first training step, to generate the map representation of the environment based on the labeled environmental sensor data of the second training dataset, wherein the generation of the map representation is configured for onboard map generation.

2. The method according to claim 1, wherein at least one of:
the first training step is self-supervised training,
the second training step is executed taking into account ground truth information, or
the ground truth information is based on a high-resolution map.

3. The method according to claim 1, further comprising the following steps:
receiving map data of an electronic road map by the perception system, wherein at least one of: (i) the map data reproduce the environment of the vehicle, or (ii) the road map is a standard resolution map;
ascertaining road marking information of roads of the road map based on the map data; and
taking into account the map data of the road map, to which the road marking information has been added, as a pseudo-label in the training of the map prediction module in the first training step.

4. The method according to claim 3, wherein the ascertainment of the road marking information includes:
extracting a map extract from the road map for each data point of the environmental sensor data, the map extract being arranged around a vehicle position defined by the data point;
converting the extracted map extract into vehicle coordinates;
ascertaining the road marking information based on the vehicle coordinates, taking into account estimated road widths and estimated numbers of lanes per road.

5. The method according to claim 4, wherein at least one of: (i) each of the road widths and/or the numbers of lanes are estimated based on information relating to a road type and/or a lane type and/or based on country-specific and/or region-specific information, (ii) the map extracts are ascertained taking into account a selectable prediction range, (iii) the vehicle positions are ascertained taking into account GPS-based position information and/or based on visual landmarks, or (iv) the ascertainment of the road marking information includes:
combining the ascertained lanes to form lines and/or line segments.

6. The method according to claim 1, wherein at least one of:
the environmental sensor data of the first training data set and/or the second training dataset include image data and/or video data, or
the method further comprises the following steps:
converting the environmental sensor data of the first training dataset and/or of the second training dataset into birds-eye-view features, and
extracting map features based on the birds-eye-view features, wherein the map features are used as input data for the map prediction module.

7. The method according to claim 1, wherein the first training step and/or the second training step further include:
at least one of: (i) training a detection module of the perception system for object detection, or (ii) training an occupancy module of the perception system for generating an occupancy network.

8. The method according to claim 1, wherein at least one of:
(i) separate partial loss functions are used for training the map prediction module and/or the object detection module and/or the occupancy network module,
(ii) a total loss function including the partial loss functions is used for training the perception system, or
(iii) the partial loss functions are combined in a weighted sum in the total loss function.

9. A computing unit that is configured to train a perception system for a vehicle that can be driven autonomously, the computing unit configured to:
provide a first training dataset, wherein the first training dataset includes unlabeled environmental sensor data, and wherein the environmental sensor data reproduce an environment of a vehicle;
execute a first training step of a map prediction module of the perception system to generate a map representation of the environment of the vehicle based on the environmental sensor data of the first training dataset;
provide a second training dataset, wherein the second training dataset includes labeled environmental sensor data; and
execute a second training step of the map prediction module of the perception system pretrained in the first training step, to generate the map representation of the environment based on the labeled environmental sensor data of the second training dataset, wherein the generation of the map representation is configured for onboard map generation.

10. A non-transitory computer-readable medium on which is stored a computer program including commands for training a perception system for a vehicle that can be driven autonomously, the commands, when executed by a data processor, causing the data processor to perform the following steps comprising:
providing a first training dataset, wherein the first training dataset includes unlabeled environmental sensor data, and wherein the environmental sensor data reproduce an environment of a vehicle;
executing a first training step of a map prediction module of the perception system to generate a map representation of the environment of the vehicle based on the environmental sensor data of the first training dataset;
providing a second training dataset, wherein the second training dataset includes labeled environmental sensor data; and
executing a second training step of the map prediction module of the perception system pretrained in the first training step, to generate the map representation of the environment based on the labeled environmental sensor data of the second training dataset, wherein the generation of the map representation is configured for onboard map generation.
